(19) United States
(12) Patent Application Publication
(10) Pub. No.: US 2016/0009956 A1
(43) Pub. Date: Jan. 14, 2016

(54) ADHESIVE FILM FOR DISPLAY DEVICE AND MANUFACTURING METHOD THEREOF

(71) Applicant: Samsung Display Co., Ltd., Yongin-city (KR)

(72) Inventor: Hyeon Deuk Hwang, Cheonan-si (KR)

(21) Appl. No.: 14/572,338

(22) Filed: Dec. 16, 2014

(30) Foreign Application Priority Data
Jul. 8, 2014 (KR) 10-2014-0085011

(51) Int. Cl. C09J 7/02; B32B 37/12; B32B 38/00; C09J 133/08

(52) U.S. Cl. CPC C09J 7/0228; C09J 7/02; C09J 133/08; B32B 37/12; B32B 38/0008; C09J 2433/00; C09J 2201/162; B32B 2405/00

(57) ABSTRACT

An adhesive film for a display device may include an upper release film, a lower release film facing the upper release film, and a photocurable adhesive interposed between the upper and lower release films. The photocurable adhesive may include a first area having a predetermined shape and a second area having a different storage modulus from the first area.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims priority to and the benefit of Korean Patent Application No. 10-2014-0085011, filed on Jul. 8, 2014, with the Korean Intellectual Property Office, the disclosure of which is incorporated herein in its entirety by reference.

### BACKGROUND

1. Field

The disclosure relates to an adhesive film for a display device capable of being used in a lamination process of a display panel having various shapes, and to a method for manufacturing the same.

2. Description of the Related Technology

A display device is a device for displaying an image signal externally input and is used in, for example, televisions or monitors. A display device includes a display panel for displaying an image and a window, which are bonded to each other.

As a display panel, plasma display panels (PDPs) or liquid crystal displays (LCDs) have been widely used, and organic light emitting diodes (OLEDs) are also increasingly being used.

There is a known method of bonding a display panel to a window, and in the known method, a resin that is a UV curing adhesive is applied to the display panel and then is irradiated with UV light so as to be cured to a solid.

However, a resin is liquid, and thus it is difficult to control a shape of the resin when diffused after it is applied to a display panel and disadvantageously overflows out of a display device.

There is another known method of bonding a display panel to a window by a lamination process using an optically clear adhesive (OCA), which is then subjected to an autoclave treatment.

In the case of using an optically clear adhesive (OCA), resin overflow can be removed, however, gas inclusions are generated in a print stepped portion of a black matrix (BM) in a window and lifting occurs under high-temperature conditions because the OCA has a large thickness, thereby decreasing reliability.

The gas inclusion or lifting frequently occurs in a display device formed in various shapes such as a circle, not a square or rectangle.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding effective filing dates of subject matter disclosed herein.

### SUMMARY

Embodiments of the present disclosure relate to an adhesive film configured to uniformly bond a display panel to a window in a display device including a variously shaped display panel, and to a mass production method of manufacturing the same.

According to an embodiment, an adhesive film for a display device includes an upper release film, a lower release film facing the upper release film, and a photocurable adhesive interposed between the upper and lower release films. The photocurable adhesive may include a first area having a predetermined shape and a second area having a different storage modulus from the first area.

The upper and lower release films may be a plastic film made of one of polyimide, polyethylene terephthalate (PET), polyethylene naphthalate (PEN), polyethersulfone (PES), nylon, polytetrafluoroethylene (PTFE), polyetheretherketone (PEEK), polycarbonate, and polyarylate.

The photocurable adhesive may include an acrylic polymer and a photocurable compound.

The acrylic polymer may be an alkyl acrylate monomer selected from the group consisting of methyl acrylate, ethyl acrylate, propyl acrylate, butyl acrylate, pentyl acrylate, hexyl acrylate, octyl acrylate, lauryl acrylate, and tetradecyl acrylate.

The acrylic polymer may further comprise an acrylic-acid based compound.

The photocurable compound may further comprise a photocurable monomer and a photocurable oligomer.

The photocurable compound may comprise a photocurable monomer selected from the group consisting of hexanediol diacrylate (HDDA), tripropylene glycol diacrylate (TPGDA), trimethylolpropane triacrylate (TMPTA), hexamethylene (HEA), hydroxylpropyl acrylate (HPA), hydroxylbutyl acrylate (HBA), isobonyl acrylate (IBOA), acryloyl morpholine (ACMO), and tetrahydrofurfuryl acrylate (THFA).

The photocurable compound may comprise a photocurable oligomer selected from the group consisting of urethane acrylate, polyester acrylate, polyether acrylate, epoxy acrylate, polybutadiene acrylate, and silicone acrylate.

The acrylic polymer may be formed by polymerization of about 30 wt % to about 60 wt % of a butyl acrylate monomer, about 30 wt % to about 60 wt % of an ethyl acrylate monomer, and about 0.1 wt % to about 15 wt % of acrylic acid.

The photocurable compound may include a mixture of about 5 wt % to about 50 wt % of an aliphatic urethane acrylate oligomer, about 5 wt % to about 50 wt % of trimethylolpropane triacrylate, and about 5 wt % to about 50 wt % of hexanediol diacrylate.

The photocurable adhesive may include about 70 wt % to about 95.5 wt % of the acrylic polymer and about 0.5 wt % to about 30 wt % of the photocurable compound.

The first area of the photocurable adhesive may be formed by light radiation and may have the same shape as a display panel.

According to another embodiment, a method for manufacturing an adhesive film for a display device includes preparing upper and lower release films, applying a photocurable adhesive to one surface of the lower release film, attaching the upper release film onto the photocurable adhesive to face the lower release film, forming a mask pattern on the upper release film, and irradiating light onto the mask pattern.

In the preparation of the release films, the upper and lower release films may be a plastic film formed of one of polyimide, polyethylene terephthalate (PET), polyethylene naphthalate (PEN), polyethersulfone (PES), nylon, polytetrafluoroethylene (PTFE), polyetheretherketone (PEEK), polycarbonate, and polyacrylate.

In the applying of the photocurable adhesive, the photocurable adhesive may include an acrylic polymer and a photocurable compound.

The acrylic polymer may be formed by polymerization of about 30 wt % to about 60 wt % of a butyl acrylate monomer, about 30 wt % to about 60 wt % of an ethyl acrylate monomer, and about 0.1 wt % to about 15 wt % of acrylic acid.

The photocurable compound may include a mixture of about 5 wt % to about 50 wt % of an aliphatic urethane acrylate oligomer, about 5 wt % to about 50 wt % of trimethylolpropane triacrylate, and about 5 wt % to about 50 wt % of hexanediol diacrylate.

The photocurable adhesive may include about 70 wt % to about 95.5 wt % of the acrylic polymer and about 0.5 wt % to about 30 wt % of the photocurable compound.

The forming of the mask pattern may include printing ink on the upper release film, and further the mask pattern may be formed to have the same shape as a display panel.

According to yet another embodiment, a method for manufacturing a display device includes bonding a display panel and a window to each other utilizing the adhesive film for a display device.

According to embodiments of the present invention, an adhesive film for a display device includes a photocurable adhesive including a photocurable compound, thereby improving step filling and adhesive strength of an interface, and because the adhesive film has a small thickness, gas inclusions may be reduced in a print stepped portion of a black matrix (BM) in a window and lifting may also be reduced under high-temperature conditions when a lamination process is performed.

Further, an area of the photocurable adhesive may have the same shape as a display panel and the storage modulus of the area may differ from that of the other area having different shapes from the display panel so that the other area may be easily detached from the photocurable adhesive and the area having the same shape as the display panel may be formed into a variety of shapes, and accordingly a display panel with many different shapes may be uniformly bonded to a window.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure will be more clearly understood from the following detailed description taken in conjunction with the accompanying drawings, in which:

FIG. 1 is a cross-sectional view illustrating an adhesive film for a display device according to an embodiment;

FIG. 2 is a plan view illustrating a photocurable adhesive included in the adhesive film for a display device illustrated in FIG. 1;

FIG. 3 is a schematic block diagram illustrating a method of manufacturing an adhesive film for a display device according to an embodiment;

FIG. 4 is a diagram providing one embodiment of a method of manufacturing a display device in which a display panel is bonded to a window utilizing the adhesive film for a display device illustrated in FIG. 1;

FIG. 5 is a diagram providing one embodiment of a method of manufacturing a display device in which a window, a touch film, and a display panel are sequentially bonded together utilizing the adhesive film for a display device illustrated in FIG. 1; and

FIG. 6 is a diagram providing one embodiment of a method of manufacturing a flexible display device in which a flexible display panel, a touch film, and a window are sequentially bonded together utilizing the adhesive film for a display device illustrated in FIG. 1.

### DETAILED DESCRIPTION

Advantages and features of structures formed in accordance with the present disclosure and methods for achieving them will be made clear from embodiments described below in more detail with reference to the accompanying drawings. The present teachings may, however, be embodied in many different forms and should not be construed as being limited to the specific embodiments set forth herein. Rather, these embodiments are provided so that this disclosure will be thorough and complete, and will fully convey the scope of the present teachings to those skilled in the pertinent art. Like reference numerals refer to like elements throughout the specification.

The spatially relative terms “below”, “beneath”, “lower”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

The terminology used herein is for the purpose of describing particular embodiments only and is not construed as limiting the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of mentioned component, step, operation and/or element, but do not exclude the presence or addition of one or more other components, steps, operations and/or elements.

Unless otherwise defined, all terms used herein (including technical and scientific terms) have the same meaning as commonly understood by those skilled in the art to which this disclosure of invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

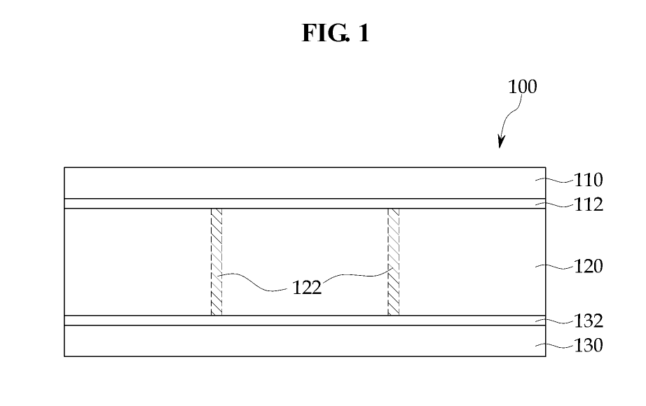

Referring to FIG. 1, an adhesive film 100 for a display device according to an embodiment includes an upper release film 110, a lower release film 130 facing the upper release film 110, and a photocurable adhesive 120 interposed between the upper and lower release films 110 and 130.

The upper and lower release films 110 and 130 may temporarily protect an adhesive surface of the photocurable adhesive 120 from being contaminated with dust, debris, moisture, and other contaminants and one surface or both surfaces of the upper and lower release films 110 and 130 may be subjected to a release treatment so that release-treated layers 112 and 132 may be formed.

The upper and lower release films 110 and 130 may be a plastic film made of polyimide, polyethylene terephthalate (PET), polyethylene naphthalate (PEN), polyethersulfone (PES), nylon, polytetrafluoroethylene (PTFE), polyetheretherketone (PEEK), polycarbonate, or polyacrylate.

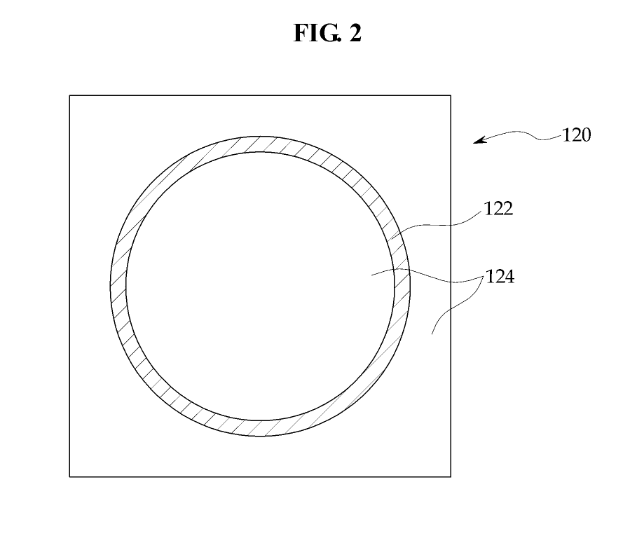

The photocurable adhesive 120 may serve to bond a display panel, a window, and/or a touch film to each other and a detailed shape of the photocurable adhesive 120 will be described below with reference to FIG. 2.

The photocurable adhesive 120 may include an acrylic polymer and a photocurable compound and may desirably include about 70 wt % to about 95.5 wt % of the acrylic polymer and about 0.5 wt % to about 30 wt % of the photocurable compound in consideration of adhesive strength.

The acrylic polymer may include, but not limited to, an alkyl acrylate monomer such as methyl acrylate, ethyl acrylate, propyl acrylate, butyl acrylate, pentyl acrylate, hexyl acrylate, octyl acrylate, lauryl acrylate, or tetradecyl acrylate. The acrylic polymer may further include an acrylic acid-based compound.

The acrylic polymer may be formed by polymerizing about 30 wt % to about 60 wt % of a butyl acrylate monomer, about 30 wt % to about 60 wt % of an ethyl acrylate monomer, and about 0.1 wt % to about 15 wt % of acrylic acid.

The photocurable compound may include a photocurable monomer or a photocurable oligomer and the photocurable monomer or photocurable oligomer may be a UV curable monomer or UV curable oligomer.

The photocurable monomer may include, but not limited to, at least one of hexanediol diacrylate (HDDA), tripropylene glycol diacrylate (TPGDA), trimethylolpropane triacrylate (TMPTA), hexamethylene (HEA), hydroxyl propyl acrylate (HPA), hydroxyl butyl acrylate (HBA), isobonyl acrylate (IBOA), acryloyl morpholine (ACMO), and tetrahydrofurfuryl acrylate (THFA).

The photocurable oligomer may include, but not limited to, at least one of urethane acrylate, polyester acrylate, polyether acrylate, epoxy acrylate, polybutadiene acrylate, and silicone acrylate.

The photocurable compound may desirably include a mixture of about 5 wt % to about 50 wt % of an aliphatic urethane acrylate oligomer, about 5 wt % to about 50 wt % of trimethylolpropane triacrylate, and about 5 wt % to about 50 wt % of hexanediol diacrylate.

The photocurable adhesive 120 may include a photocurable compound, e.g., a UV curable compound, and thus when irradiated with UV light, a curing reaction may take place such that the storage modulus of the photocurable adhesive 120 may increase from a range of 10³ Pa to 10⁵ Pa before the ultraviolet (UV) irradiation to a range of 10⁶ Pa to 10⁷ Pa after the UV irradiation.

Therefore, the photocurable adhesive 120 may have outstanding evenness and adhesive strength of an interface, which are similar to a resin, and may be effectively formed in a film form like an optically clear adhesive (OCA).

Referring to FIG. 2, the photocurable adhesive 120 may be divided into two areas: a first area 122 having a predetermined shape and a second area 124 that is the remaining area of the photocurable adhesive 120.

The first area 122 may be formed by a curing reaction of the photocurable compound caused by light irradiation. The first area 122 may have various shapes (e.g., a circle) according to the shape of a mask pattern, but it may desirably have the same shape as a display panel. However, the scope of the present disclosure is not limited thereto.

The first area 122 irradiated with light and the second area 124 which is non-irradiated may be different from each other in terms of storage modulus. The first area 122 may have a higher storage modulus than the second area 124, and thus the first area 122 may be easily detached from the photocurable adhesive 120 to be formed into many different shapes such as a circle so that a display panel having various shapes may be uniformly bonded to a window.

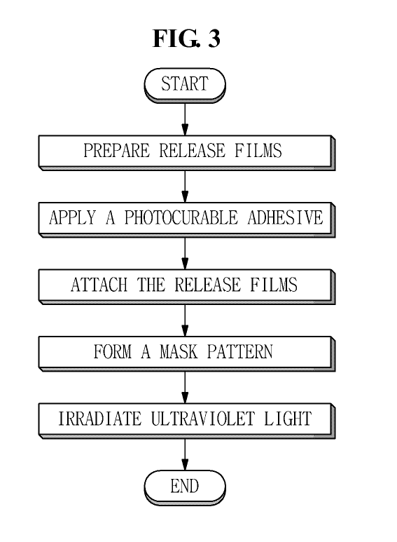

Referring to FIG. 3, a method of manufacturing an adhesive film for a display device according to one embodiment includes preparing an upper release film and a lower release film, applying a photocurable adhesive to one surface of the lower release film, attaching the upper release film onto the photocurable adhesive so as to face the lower release film, forming a mask pattern on the upper release film, and irradiating light onto the mask pattern.

The upper and lower release films in the preparing of the release films and the photocurable adhesive in the applying of the photocurable adhesive may be configured in the same manner as the adhesive film for a display device illustrated in FIG. 1, and thus detailed description thereof will be omitted for brevity.

In the forming of the mask pattern, the mask pattern may print ink on the upper release film, but embodiments of the present invention are not limited thereto. A mask made of a metal material completely blocking light transmitted through a region where the pattern is not formed or made of a polymer film such as polyimide may be used. It is desirable for the mask pattern to have the same shape as a display panel.

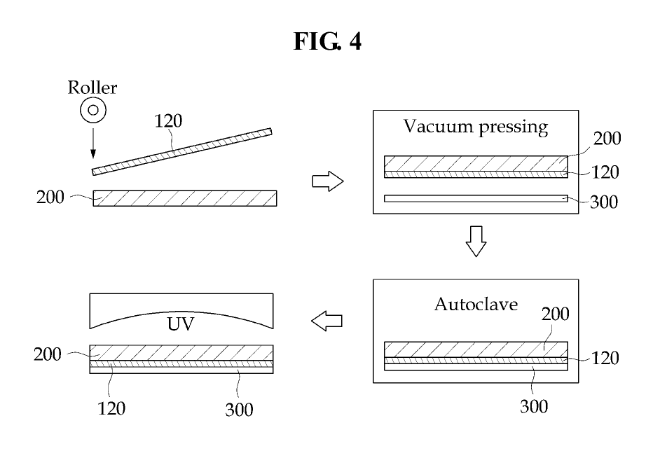

Referring to FIG. 4, a method of manufacturing a display device in which a window and a display panel are bonded to each other utilizing an adhesive film for a display device according to one embodiment will be described below.

An upper or lower release film of the adhesive film for a display device according to one embodiment may be removed from the adhesive film, and then a photocurable adhesive 120 may be attached to a window 200 by roll lamination.

Next, a display panel 300 and the window 200 may be first bonded to each other by vacuum lamination, and thereafter the display panel 300 and the window 200 may be second bonded to each other by an autoclave treatment.

Finally, the photocurable adhesive 120 may be cured by UV irradiation so that a display device may be manufactured, in which the window 200 and the display panel 300 may be uniformly bonded together by the photocurable adhesive 120.

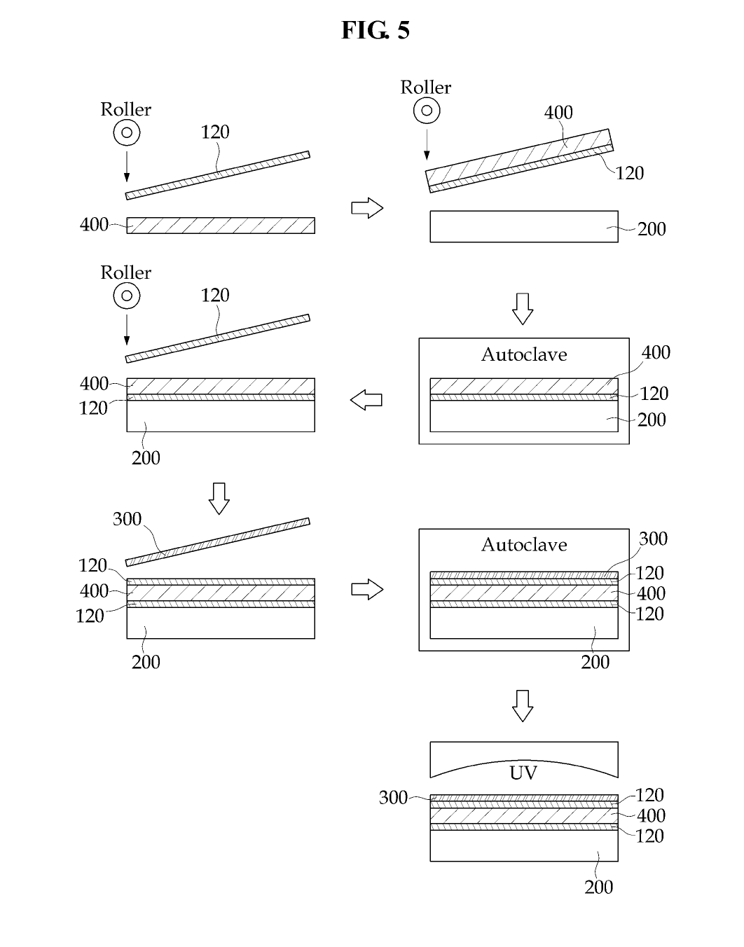

Referring to FIG. 5, a method of manufacturing a display device in which a window, a touch film, and a display panel are sequentially bonded together utilizing an adhesive film for a display device according to one embodiment will be described below.

An upper or lower release film of the adhesive film for a display device according to one embodiment may be removed from the adhesive film, and then a photocurable adhesive 120 may be attached to a touch film 400 by first roll lamination. Thereafter, the touch film 400 may be first bonded to a window 200 by second roll lamination and the touch film 400 and the window 200 may be second bonded to each other by the autoclave treatment.

Next, the photocurable adhesive 120 in which the upper or lower release film of the adhesive film for a display device according to one embodiment is removed from the adhesive film may be attached to the touch film 400 by first roll lamination. Thereafter, the window 200 bonded to the touch film 400 may be first bonded to a display panel 300 by second roll lamination and the window 200 bonded to the touch film 400 may be second bonded to the display panel 300 by the autoclave treatment.

Finally, the photocurable adhesive 120 may be cured by UV irradiation so that a display device may be manufactured, in which the window 200, the touch film 400, and the display panel 300 may be sequentially and uniformly bonded together by the photocurable adhesive 120.

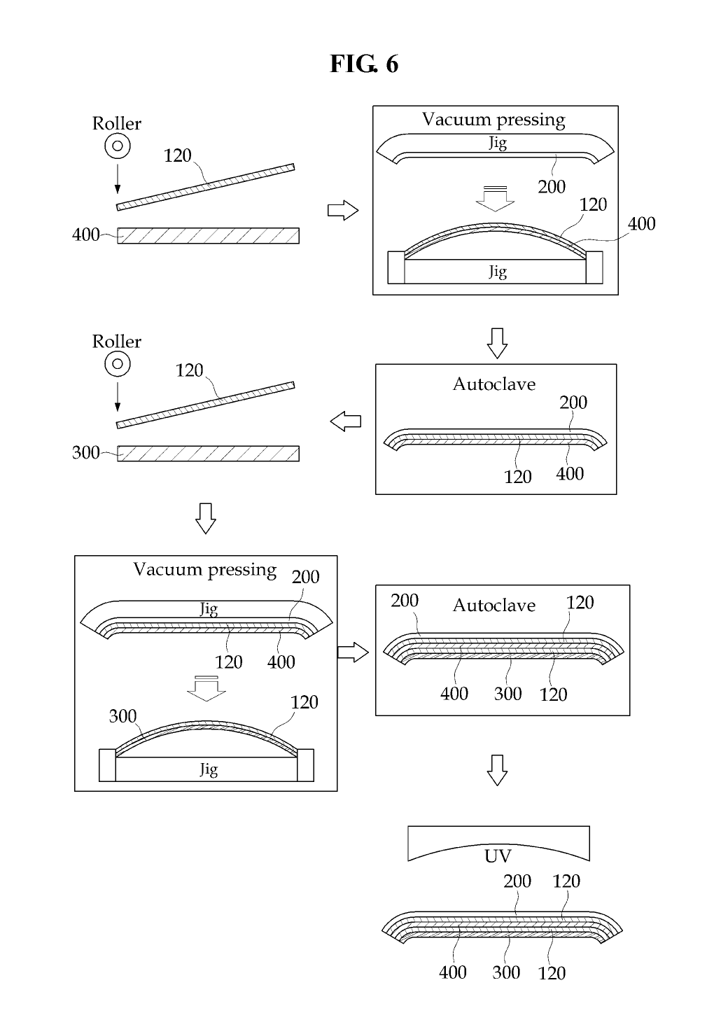

Referring to FIG. 6, a method of manufacturing a flexible display device in which a flexible display panel, a touch film, and a window are sequentially bonded together utilizing an adhesive film for a display device according to one embodiment will be described below.

An upper or lower release film of the adhesive film for a display device according to one embodiment may be removed from the adhesive film, and then a photocurable adhesive 120 may be attached to a touch film 400 by roll lamination. Thereafter, the touch film 400 deformed by a jig may be first bonded to a window 200 by vacuum lamination and the touch film 400 and the window 200 may be second bonded to each other by the autoclave treatment.

Next, the photocurable adhesive 120 in which the upper or lower release film of the adhesive film for a display device according to one embodiment is removed from the adhesive film may be attached to a flexible display panel 300 by the roll lamination. Thereafter, the window 200 bonded to the touch film 400 deformed by a jig may be first bonded to the flexible display panel 300 by vacuum lamination and the window 200 bonded to the touch film 400 may be second bonded to the flexible display panel 300 by the autoclave treatment.

Finally, the photocurable adhesive 120 may be cured by UV irradiation so that a flexible display device may be manufactured, in which the flexible display panel 300, the touch film 400, and the window 200 may be sequentially and uniformly bonded together by the photocurable adhesive 120.

From the foregoing, it will be appreciated that while the inventive technology has been described herein for purposes of illustration, and that various modifications may be made without departing from the scope and spirit of the present teachings. Accordingly, the various embodiments disclosed herein are not intended to be limiting of the true scope and spirit of the present teachings.

What is claimed is:

1. An adhesive film for a display device, comprising:
an upper release film;
a lower release film facing the upper release film; and
a photocurable adhesive interposed between the upper and lower release films,
wherein the photocurable adhesive comprises a first area having a predetermined shape and a second area having a different storage modulus from the first area.

2. The adhesive film for a display device of claim 1, wherein the upper and lower release films are a plastic film made of one of polyimide, polyethylene terephthalate (PET), polyethylene naphthalate (PEN), polyethersulfone (PES), nylon, polytetrafluoroethylene (PTFE), polyetheretherketone (PEEK), polycarbonate, and polyarylate.

3. The adhesive film for a display device of claim 1, wherein the photocurable adhesive comprises an acrylic polymer and a photocurable compound.

4. The adhesive film for a display device of claim 3, wherein the acrylic polymer is an alkyl acrylate monomer selected from the group consisting of methyl acrylate, ethyl acrylate, propyl acrylate, butyl acrylate, pentyl acrylate, hexyl acrylate, octyl acrylate, lauryl acrylate, and tetradecyl acrylate.

5. The adhesive film for a display device of claim 3, wherein the acrylic polymer may further comprise an acrylic-acid based compound.

6. The adhesive film for a display device of claim 3, wherein the photocurable compound may further comprise a photocurable monomer and a photocurable oligomer.

7. The adhesive film for a display device of claim 3, wherein the photocurable compound is a photocurable monomer selected from the group consisting of hexanediol diacrylate (HDDA), tripropylene glycol diacrylate (TPGDA), trimethylolpropane triacrylate (TMPTA), hexamethylene (HEA), hydroxyl propyl acrylate (HPA), hydroxyl butyl acrylate (HBA), isobonyl acrylate (IBOA), acryloyl morpholine (ACMO), and tetrahydrofurfuryl acrylate (THFA).

8. The adhesive film for a display device of claim 3, wherein the photocurable compound is a photocurable oligomer selected from the group consisting of urethane acrylate, polyester acrylate, polyether acrylate, epoxy acrylate, polybutadiene acrylate, and silicone acrylate.

9. The adhesive film for a display device of claim 3, wherein the acrylic polymer is formed by polymerization of about 30 wt % to about 60 wt % of a butyl acrylate monomer, about 30 wt % to about 60 wt % of an ethyl acrylate monomer, and about 0.1 wt % to about 15 wt % of acrylic acid.

10. The adhesive film for a display device of claim 3, wherein the photocurable compound comprises a mixture of about 5 wt % to about 50 wt % of an aliphatic urethane acrylate oligomer, about 5 wt % to about 50 wt % of trimethylolpropane triacrylate, and about 5 wt % to about 50 wt % of hexanediol diacrylate.

11. The adhesive film for a display device of claim 3, wherein the photocurable adhesive comprises about 70 wt % to about 95.5 wt % of the acrylic polymer and about 0.5 wt % to about 30 wt % of the photocurable compound.

12. The adhesive film for a display device of claim 1, wherein the first area is formed by light radiation and has the same shape as a display panel.

13. A method for manufacturing an adhesive film for a display device, the method comprising:
preparing upper and lower release films;
applying a photocurable adhesive on one surface of the lower release film;
attaching the upper release film onto the photocurable adhesive to face the lower release film;
forming a mask pattern on the upper release film; and
irradiating light onto the mask pattern.

14. The method of claim 13, wherein in the preparing of the release films, the upper and lower release films are a plastic film formed of one of polyimide, polyethylene terephthalate (PET), polyethylene naphthalate (PEN), polyethersulfone (PES), nylon, polytetrafluoroethylene (PTFE), polyetheretherketone (PEEK), polycarbonate, and polyacrylate.

15. The method of claim 13, wherein in the applying of the photocurable adhesive, the photocurable adhesive comprises an acrylic polymer and a photocurable compound.

16. The method of claim 15, wherein the acrylic polymer is formed by polymerization of about 30 wt % to about 60 wt % of a butyl acrylate monomer, about 30 wt % to about 60 wt % of an ethyl acrylate monomer, and about 0.1 wt % to about 15 wt % of acrylic acid.

17. The method of claim 15, wherein the photocurable compound comprises a mixture of about 5 wt % to about 50 wt % of an aliphatic urethane acrylate oligomer, about 5 wt % to about 50 wt % of trimethylolpropane triacrylate, and about 5 wt % to about 50 wt % of hexanediol diacrylate.

18. The method of claim 15, wherein the photocurable adhesive comprises about 70 wt % to about 95.5 wt % of the acrylic polymer and about 0.5 wt % to about 30 wt % of the photocurable compound.

19. The method of claim 13, wherein the forming of the mask pattern comprises printing ink on the upper release film.

20. The method of claim 19, wherein the mask pattern is formed to have the same shape as a display panel.
